(19) United States
(12) Patent Application Publication
(10) Pub. No.: US 2008/0170016 A1
(43) Pub. Date: Jul. 17, 2008

(54) Liquid crystal device, method for driving the liquid crystal device and electronic equipment

(76) Inventors: Hiroshi Wada, Nagano-ken (JP); Minoru Ikeda, Matsumoto-shi (JP)

Correspondence Address: HARNESS, DICKEY & PIERCE, P.L.C., P.O. BOX 828, BLOOMFIELD HILLS, MI, 48303, US

(21) Appl. No.: 10/666,855

(22) Filed: Sep. 19, 2003

(30) Foreign Application Priority Data
Sep. 20, 2002 (JP) 2002-275760
Sep. 12, 2003 (JP) 2003-321981

(51) Int. Cl. G09G 3/36

(52) U.S. Cl. 345/87

(57) ABSTRACT

A liquid crystal device is provided with wiring lines on a second substrate. The signal lines are connected to common electrodes provided on a first substrate at their ends overlaying a sealing material. The wiring lines extend in an area surrounded by the inside edges of the sealing material on the first substrate. The effective value of a voltage applied to the liquid crystals at cross sections between one of the wiring lines and common electrodes other than the common electrode connected to the corresponding wiring line among the multiple common electrodes is set to be smaller than the effective value of a voltage applied to the corresponding pixel for turning on the pixel.

### BACKGROUND OF THE INVENTION

1. Field of Invention

The present invention relates to a liquid crystal device, a method for driving the liquid crystal device, and electronic equipment provided with the liquid crystal device.

2. Related Art

Liquid crystal devices are in widespread use as display devices for a variety of electronic equipment such as mobile phones. As is commonly known, liquid crystal devices generally have a structure in which liquid crystals are sandwiched between a pair of substrates that are bonded to each other through a sealing material. Electrodes are provided on the opposing faces of both substrates. A voltage is applied to these electrodes in accordance with images to be displayed through wiring lines that are connected to the electrodes.

A structure in which wiring lines that are connected to electrodes on both substrates are densely formed on one substrate is also proposed. FIG. 17 is a plan view showing the structure of a liquid crystal device of this kind. On a liquid crystal device 80 in FIG. 17, a rear substrate 81 has an area extending from the lower edge of an observed substrate 82. A driving IC chip 83 is mounted on this extended area. A plurality of segment electrodes 811 are formed in a stripe pattern on the face of the rear substrate 81 that faces the liquid crystals. The segment electrodes 811 are connected to the output terminal of the driving IC chip 83 through the respective wiring lines 812. In contrast, a plurality of common electrodes 821 is formed in a stripe pattern on the face of the observed substrate 82 that opposes the liquid crystals. Each of the common electrodes 821 is connected to the corresponding wiring line 813 provided on the rear substrate 81 through conductive particles dispersed in a sealing material 84. The wiring lines 813 extend in an area outside the sealing material 84 on the rear substrate 81 and the lower ends thereof are connected to the output terminal of the driving IC chip 83. With this structure, it is sufficient for the driving IC chip 83 to be mounted only on the rear substrate 81, thus achieving a simplified structure, compared with a liquid crystal device having driving IC chips mounted on both the rear substrate 81 and the observed substrate 82.

However, since it is necessary to allocate an area where the wiring lines 813 are arranged outside the sealing material 84. In the structure in FIG. 17, an area, outside the sealing material 84, which does not contribute to display (hereinafter referred to as a “frame area”) is limitedly narrowed under the current situation. In order to increase the number of pixels in response to the need for more precise display in recent years, the wiring lines 813 must be increased in number, so it becomes more difficult to narrow the frame area.

Alternatively, the wiring lines 813 may be spaced at smaller intervals for narrowing the frame area in the structure in FIG. 17. However, the wiring lines 813 increase in resistance in this case, thus possibly decreasing the quality of display. Furthermore, since the wiring lines 813 are open to the outside air in the structure in FIG. 17, absorption of moisture in the outside air and so on undesirably cause the wiring lines 813 to be short-circuited or corroded.

The present invention is addressed to solve such problems. Accordingly, an object of the present invention is to provide a liquid crystal device, a method for driving the liquid crystal device, and electronic equipment provided with the liquid crystal device, which are capable of narrowing the frame area without defects, such as reduction in reliability of wiring lines or short-circuited wiring.

### SUMMARY

A liquid crystal device according to the present invention has liquid crystals between a first substrate and a second substrate that opposes the first substrate through a sealing material. Pixels corresponding to intersections of a plurality of first electrodes on the first substrate and a plurality of second electrodes on the second substrate are turned on or off in accordance with voltages applied to the first electrodes and the second electrodes. The liquid crystal device includes wiring lines, provided on the second substrate, which are connected to the first electrodes on the first substrate and each have a part extending in an area surrounded by the inside edges of the sealing material, and a drive circuit for applying a voltage to the first electrodes through the wiring lines such that the effective value of a voltage applied to the liquid crystals at the cross sections between one of the wiring lines and first electrodes other than the first electrode connected to the corresponding wiring line among the multiple first electrodes is smaller than the effective value of a voltage applied to the corresponding pixel for turning on the pixel.

With this structure, since the wiring lines connected to the first (common) electrodes extend in an area surrounded by the inside edges of the sealing material, the frame area can be reduced in size, compared with a known liquid crystal device having wiring lines in an area outside the sealing material on the substrate. Furthermore, part of the wiring lines in the area surrounded by the inside edges of the sealing material are not open to the outside air, thus preventing the wiring lines from being short-circuited or corroded due to absorption of moisture in the outside air and so on to increase in reliability.

With the structure having the wiring lines that extend in an area surrounded by the inside edges of the sealing material, one of the wiring lines and first electrodes other than the first electrode connected to the corresponding wiring line among the multiple first electrodes are two-dimensionally crossed with each other. Sequentially supplying the scanning signals to, for example, the multiple first electrodes in this structure causes a voltage to be applied between the wiring lines and the first electrodes that are opposed to each other through the liquid crystals sandwiched therebetween, thus varying the orientation of the liquid crystals at these cross sections (that is, lighting up the corresponding pixels). Accordingly, there is a problem in that the pixels at the cross sections may light up although they should not normally light up.

Hence, in the liquid crystal device of the present invention, a voltage is applied to the first electrodes through the respective wiring lines such that the effective value of a voltage applied to the liquid crystals at cross sections between one of the wiring lines and first electrodes other than the first electrode connected to the corresponding wiring line among the multiple first electrodes is smaller than the effective value of a voltage applied to the corresponding pixel for turning on the pixel. With this structure, the lighting-up at the cross sections can be suppressed, compared with a case in which a voltage effective value that is larger than the effective value of the voltage applied to the corresponding pixel for turning on the pixel is applied to the liquid crystals at the cross sections between the wiring line and the first electrodes.

At least either a duty ratio or a bias ratio may be determined appropriately such that the effective value of the voltage applied to the liquid crystals at the cross sections is smaller than the effective value of a voltage applied to the corresponding pixel for turning off the pixel. The inventors have found that the effective value of the voltage applied to the liquid crystals at the cross sections is decreased as the reciprocal a of a bias ratio (1/a) decreases. In view of this finding, the reciprocal a of the bias ratio (1/a) should be made small such that the effective value of the voltage applied to the liquid crystals at the cross sections is smaller than the effective value of the voltage applied to the corresponding pixel for turning off the pixel.

In view of suppressing the lighting-up at cross sections described above, it is desirable in the present invention that the effective value of the voltage applied to the liquid crystals at the cross sections be smaller than the effective value of the voltage applied to the corresponding pixel for turning on the pixel. Specifically, the effective value of the voltage applied to the liquid crystals at the cross sections is desirably set to be smaller than an intermediate value between the effective value of the voltage applied to the corresponding pixel for turning on the pixel and the effective value of the voltage applied to the corresponding pixel for turning off the pixel. Furthermore, in order to perfectly avoid the lighting-up at cross sections, the effective value of the voltage applied to the liquid crystals at the cross sections is desirably smaller than the effective value of the voltage applied to the corresponding pixel for turning off the pixel. With these structures, the orientation of the liquid crystals at the cross sections hardly varies, thus almost perfectly avoiding the lighting-up at cross sections.

In the liquid crystal device of the present invention, a light-block layer may be provided on either the first substrate or the second substrate so as to overlay the cross sections between one of the wiring lines and first electrodes other than the first electrode connected to the corresponding wiring line among the multiple first electrodes. With this layer, the lighting-up at cross sections can be further suppressed, in association with the structure in which the effective value of the voltage applied to the liquid crystals at the cross sections between the wiring lines and the first electrodes is set to be smaller than the effective value of the voltage applied to the corresponding pixel for turning off the pixel to avoid the lighting-up at cross sections.

Electronic equipment according to the present invention is characterized by having the liquid crystal device according to the present invention as a display device. As described above, since the liquid crystal device according to the present invention can reduce the size of its frame area, adaptation of the liquid crystal device as the display device of electronic equipment allows the electronic equipment to be reduced in size. Furthermore, despite the structure in which the wiring lines intersect with first electrodes other than the first electrode connected to the corresponding wiring line, the lighting-up at cross sections can be suppressed. Electronic equipment to which the present invention can be applied includes a variety of electronic equipment, such as a personal computer or a mobile phone, which has a function of displaying images.

According to the present invention, there is provided a method for driving a liquid crystal device which includes a first substrate and a second substrate that are opposed to each other through a sealing material, liquid crystals being sandwiched between the first substrate and the second substrate; a plurality of first electrodes provided on the first substrate; a plurality of second electrodes provided on the second substrate; and wiring lines, provided on the second substrate, which are connected to the first electrodes on the first substrate and each have a part extending in an area surrounded by the inside edges of the sealing material, pixels corresponding to intersections of the first electrodes and the second electrodes being turned on or off in accordance with voltages applied to the first electrodes and the second electrodes. The method for driving the liquid crystal device is characterized in that a voltage is applied to the first electrodes through the wiring lines such that the effective value of a voltage applied to the liquid crystals at cross sections between one of the wiring lines and first electrodes other than the first electrode connected to the corresponding wiring line among the multiple first electrodes becomes smaller than the effective value of a voltage applied to the corresponding pixel for turning on the pixel. With this method, for the same reason as in the liquid crystal device of the present invention, the lighting-up at cross sections between the wiring lines and the first electrodes can be suppressed, despite the liquid crystal device being reduced in size by extending the wiring lines inside the sealing material.

### BRIEF DESCRIPTION OF THE DRAWINGS

FIG. 1 is a plan view showing the structure of a liquid crystal device according to an embodiment of the present invention.

FIG. 2 is a cross-sectional view showing the structure of the liquid crystal device.

FIG. 3 is an enlarged plan view showing the structure of the liquid crystal device in the vicinity of its sealing material.

FIG. 4 is a cross-sectional view showing the structure of the liquid crystal device in the vicinity of its sealing material.

FIG. 5 is a timing chart showing the waveforms of scanning signals supplied to common electrodes in a first driving method.

FIG. 6 is a view illustrating the definition of a bias value in the first driving method.

FIG. 7 is a table showing the relationship between duty values N and bias values a, and on-voltage effective values Von, off-voltage effective values Voff, and cross-section-voltage effective values Vcross in the liquid crystal device.

FIG. 8 is a graph showing the relationship between the duty values N and bias values a, and the on-voltage effective values Von, the off-voltage effective values Voff, and the cross-section-voltage effective values Vcross in the liquid crystal device.

FIG. 9 is a timing chart showing the waveforms of scanning signals supplied to common electrodes in a second driving method.

FIG. 10 is a view illustrating the definition of a bias value in the second driving method.

FIG. 11 is a timing chart showing the waveforms of scanning signals supplied to common electrodes in a third driving method.

FIG. 12 is a view illustrating the definition of a bias value in the third driving method.

FIG. 13 is a graph showing a voltage/reflectance (transmittance) characteristic of liquid crystals.

FIG. 14 is a plan view showing the structure of a light-shielding layer of a liquid crystal device according to a modification of the present invention.

FIG. 15 is a perspective view showing the structure of a personal computer exemplifying electronic equipment provided with the liquid crystal device of the present invention.

FIG. 16 is a perspective view showing the structure of a mobile phone exemplifying the electronic equipment provided with the liquid crystal device of the present invention.

FIG. 17 is a plan view showing the structure of a known liquid crystal device.

### DETAILED DESCRIPTION

Embodiments of the present invention will be described with reference to the attached drawings. It is to be understood by those skilled in the art that the following description is preferred embodiments of the present invention. It is our intention that the invention is not limited to the following embodiments and that various changes may be made without departing from the spirit and scope of the invention. The size, ratio, or the like of components in the following drawings appropriately differs from that of actual components for preventing the drawings from being complicated.

A: Structure of Liquid Crystal Device

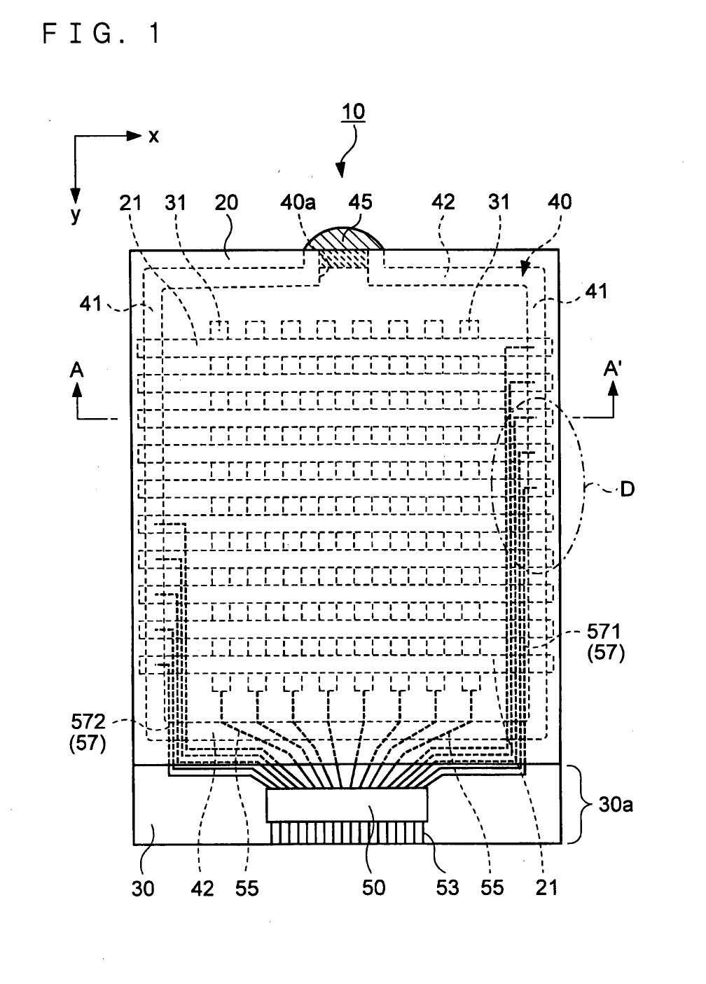

The structure of a liquid crystal device 10 according to an embodiment of the present invention will now be described with reference to FIG. 1. The liquid crystal device 10 has an observed substrate 20 and a rear substrate 30. The observed substrate 20 is bonded to the rear substrate 30 through a sealing material 40 in the shape of a substantially rectangular frame sandwiched therebetween. Liquid crystals are sealed in a space between the observed substrate 20 and the rear substrate 30 that is bonded to the observed substrate 20 through the sealing material 40. Namely, liquid crystals are injected into the space between the observed substrate 20 and the rear substrate 30 through a liquid-crystal injection port 40a opening at part of the sealing material 40. Subsequently, the liquid-crystal injection port 40a is sealed with a sealant 45. Although, in practice, a polarizer for polarizing incident light and a retardation film for correcting interference colors are appropriately adhered to the outside surfaces of the observed substrate 20 and/or the rear substrate 30, they are omitted in FIG. 1 and the subsequent drawings.

The sealing material 40 has a conductive sealing part 41 and a non-conductive sealing part 42. The conductive sealing part 41 includes two sides (two long sides opposing each other) extending in the y-axis direction in the substantially rectangular sealing material 40. Conductive particles are dispersed in the conductive sealing part 41. The conductive sealing part 41 has a function of connecting electrodes provided on both the observed substrate 20 and the rear substrate 30 through the conductive particles included therein, in addition to a function as a sealing material for holding the liquid crystals between both the substrates. In contrast, the non-conductive sealing part 42 includes two sides (two short sides opposing each other) extending in the x-axis direction in the sealing material 40. No conductive particles are dispersed in the non-conductive sealing part 42.

The observed substrate 20 and the rear substrate 30 that are made of, for example, glass or plastics are optical-transparent plate members. Since the rear substrate 30 is larger than the observed substrate 20 in external dimension, the rear substrate 30 has an area extending from one edge of the observed substrate 20. A driving IC chip 50 (drive circuit) is mounted on this extended area (hereinafter referred to as an “extended area”) 30a by chip on glass (COG) technology. The driving IC chip 50 has a circuit for supplying signals in accordance with images to be displayed to electrodes (common electrodes 21 and segment electrodes 31 described below) that are used for applying voltage to the liquid crystals. A plurality of connection terminals 53 that extend from the area where the driving IC chip 50 is mounted to one edge of the rear substrate 30 is provided on the extended area 30a. One end of each of the connection terminals 53 is connected to the input terminal of the driving IC chip 50. The other end of each of the connection terminals 53, which is near to the edge of the rear substrate 30, is connected to external equipment such as a printed circuit board through a flexible printed circuit board (not shown).

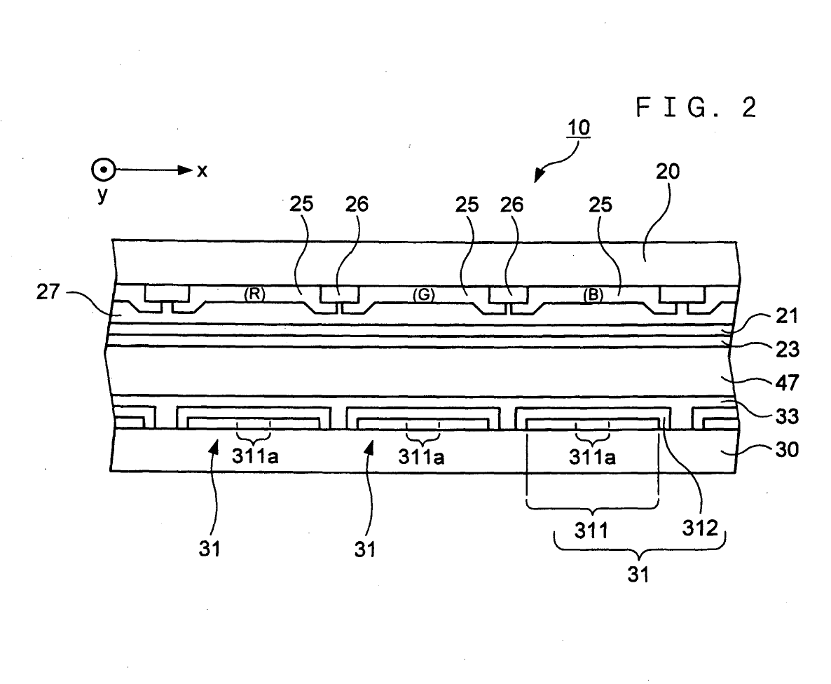

FIG. 2 is an enlarged cross-sectional view showing the structure of an area surrounded by the sealing material 40 in the cross section taken on line A-A′ in FIG. 1. Referring to FIGS. 1 and 2, the multiple common electrodes 21 extending in the x-axis direction are provided under the observed substrate 20 (at the side of liquid crystals 47). The common electrodes 21 are stripe electrodes that are spaced apart from each other and they are made of a transparent conductive material such as indium tin oxide (ITO). In contrast, the multiple segment electrodes 31 extending in the direction orthogonal to the common electrodes 21, that is, in the y-axis direction in FIG. 2 are provided on the inner face of the rear substrate 30 (at the side of liquid crystals 47). The segment electrodes 31 are stripe electrodes that are spaced apart from each other. Each of the segment electrodes 31 has a reflective conductive layer 311 and a transparent conductive layer 312 that overlays the surface and two lateral sides of the reflective conductive layer 311. Each reflective conductive layer 311 is a light-reflective and conductive thin film and is made of single metal such as aluminum or silver, an alloy containing such metal as primary ingredients (for example, an alloy of silver, palladium, and copper), or the like. Each transparent conductive layer 312 is made of a transparent conductive material such as ITO, like the common electrodes 21. Referring to FIG. 1, one end of each segment electrode 31 is connected to the corresponding wiring line 55. The wiring lines 55 extend in the y-axis direction to the extended area 30a and the ends thereof are connected to the output terminal of the driving IC chip 50. In this structure, data signals are supplied from the driving IC chip 50 to the segment electrodes 31 through the wiring lines 55.

Referring to FIG. 2, the common electrodes 21 are covered with an alignment layer 23 and the segment electrodes 31 are covered with an alignment layer 33. The alignment layer 23 and the alignment layer 33 are organic thin films made of polyimide or the like and undergo rubbing processing for specifying the orientation of the liquid crystals 47 without an applied voltage.

In this structure, the liquid crystals 47 sandwiched between the observed substrate 20 and the rear substrate 30 vary in orientation in accordance with a voltage applied between the common electrodes 21 and the segment electrodes 31. Areas where the common electrodes 21 are opposed to the segment electrodes 31, that is, minimum areas where the orientation of the liquid crystals 47 varies in accordance with the applied voltage are hereinafter referred to as “subpixels”. As seen from FIG. 1, a plurality of subpixels are arranged in a matrix form in a plane parallel to the substrates.

Referring to FIG. 2, the reflective conductive layer 311 in each of the segment electrodes 31 has a translucent area 311a corresponding to one subpixel. The translucent areas 311a are openings for transmitting light incident on the rear side of the liquid crystal device 10 to the observation side. In other words, light emitted from a backlight unit (not shown) that is provided on the rear side of the liquid crystal device 10 passes through the translucent areas 311a in the reflective conductive layers 311 toward the observation side. Visualization of the light by an observer realizes transmissive display. In contrast, outside light, such as indoor light or sunlight, which is incident on the observation side of the liquid crystal device 10 is reflected from the surfaces of the reflective conductive layers 311. Visualization by an observer of the reflected light that is emitted from the observation side realizes reflective display.

Color filters 25, light-shielding layers 26, and an overcoat layer 27 are provided under the observed substrate 20. The common electrodes 21 and the alignment layer 23 described above are provided on the upper face of the overcoat layer 27 that almost fully overlays the observed substrate 20. The overcoat layer 27 flattens the steps caused by the color filters 25 and the light-shielding layers 26.

The color filters 25 are resin layers formed for every subpixel. Each color filter 25 is colored in any one of colors, red (R), green (G), or blue (B) with dye or pigment. Three subpixels, each corresponding to one of three color filters, that is, a red filter, a green filter, or a blue filter, constitute one pixel (dot) that is a minimum unit for displayed images. The light-shielding layers 26 are formed in a lattice pattern so as to overlap the apertures between subpixels arranged in a matrix form (that is, areas other than the areas where the common electrodes 21 are opposed to the segment electrodes 31). The light-shielding layers 26 block light at the apertures between subpixels.

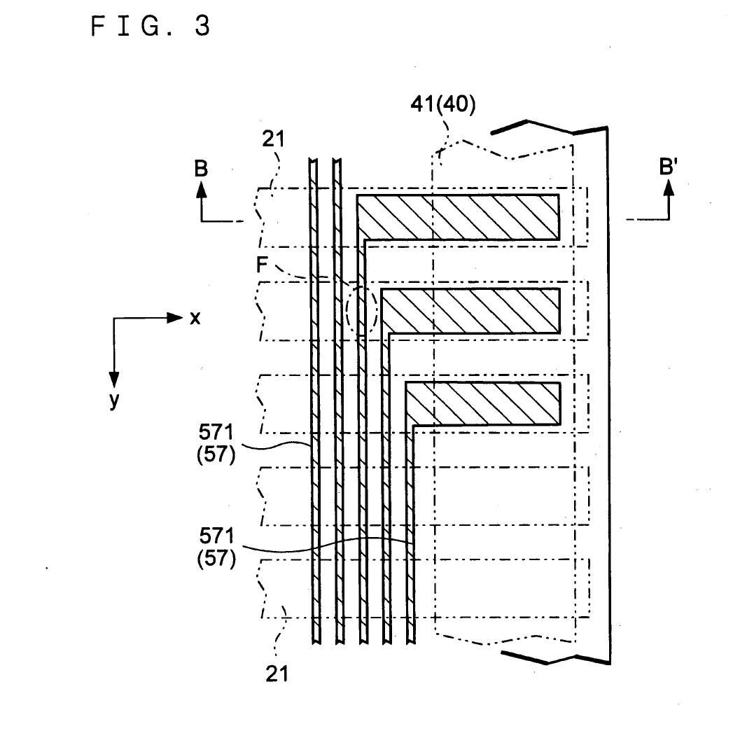

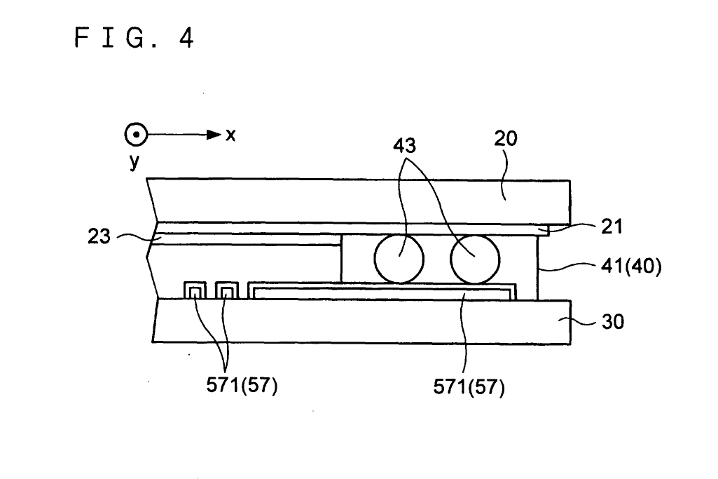

The structure in the vicinity of the sealing material 40 will now be described with reference to FIGS. 3 and 4. FIG. 3 is an enlarged view showing the structure within an ellipse D in FIG. 1. FIG. 4 is an enlarged cross-sectional view showing the structure in the vicinity of the sealing material 40 in the cross section taken on line A-A′ in FIG. 1. FIG. 4 corresponds to the cross section taken on line B-B′ in FIG. 3. Referring to FIGS. 1, 3, and 4, the multiple common electrodes 21 horizontally extend such that both ends thereof overlay the conductive sealing part 41 of the sealing material 40. Each of the common electrodes 21 is connected to the corresponding wiring line 571 provided on the rear substrate 30 through conductive particles 43 in the sealing material 40. Specifically, the right edge (the edge at the positive side of the x-axis direction) of each of the common electrodes 21 arranged in the upper half in FIG. 1 is electrically connected to the corresponding wiring line 571 through the conductive particles 43, as shown in FIG. 3. One end of each wiring line 571 opposes the right edge of the corresponding common electrode 21 through the right-side conductive sealing part 41 of the sealing material 40 sandwiched therebetween. The wiring lines 571 extend in the y-axis direction in the area surrounded by the sealing material 40. The other end of each wiring line 571 reaches the extended area 30a. The ends of the wiring lines 571 reaching the extended area 30a are connected to the output terminal of the driving IC chip 50. In contrast, the left edge (the edge at the negative side of the x-axis direction) of each of the common electrodes 21 arranged in the lower half in FIG. 1 is electrically connected to the corresponding wiring line 572 through the conductive particles 43 dispersed in the left-side conductive sealing part 41 of the sealing material 40, as shown in FIG. 1. The wiring lines 572 extend in the y-axis direction in the area surrounded by the sealing material 40 on the rear substrate 30 toward the extended area 30a, like the wiring lines 571. The ends of the wiring lines 572 reaching the extended area 30a are connected to the output terminal of the driving IC chip 50. As shown in FIG. 4, the wiring lines 571 and the wiring lines 572 have a layered structure of a reflective conductive layer made of a reflective metal and a transparent conductive layer made of a transparent conductive material, like the segment electrode 31. In the above structure, scanning signals are supplied from the driving IC chip 50 to the common electrodes 21 through the wiring lines 571 or the wiring lines 572 and the conductive particles 43 in the sealing material 40.

With the structure described above, since the wiring lines 571 and the wiring lines 572 reach the extended area 30a via the inside of the sealing material 40, the frame area can be advantageously narrowed down, compared with the structure in FIG. 17 in which the wiring lines 571 and the wiring lines 572 are arranged outside the sealing material 40. Namely, it is sufficient for the peripheral part outside the sealing material 40 on the rear substrate 30 to have a width of a print margin of the sealing material 40 (for example, around 0.3 mm). There is no need for allocating a space corresponding to the frame area.

In the liquid crystal device 10 of this embodiment, the subpixels light up in sections in the vicinity of the sealing material 40, to be more precise, in sections where the common electrodes 21 two-dimensionally intersect with the wiring lines 571 or the wiring lines 572 (for example, an area surrounded by an ellipse F in FIG. 3) (hereinafter simply referred to as “cross sections F”), although they should not light up in those areas. This phenomenon (hereinafter referred to as “lighting-up at cross sections”) will now be described in detail. When the distinction between the wiring lines 571 and the wiring lines 572 is not specifically required, both the wiring lines are collectively represented by “wiring lines 57”.

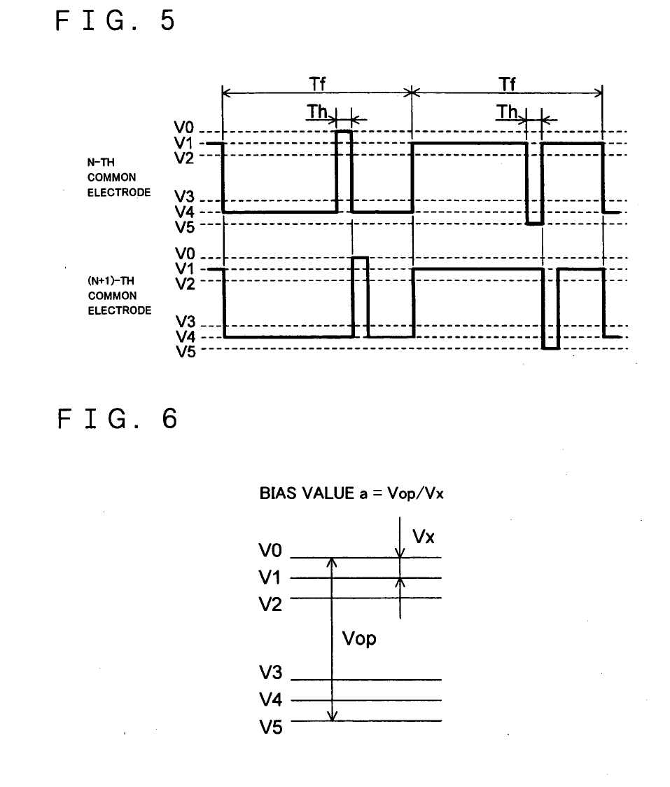

It is assumed here that scanning signals having signal waveforms shown in FIG. 5 are supplied to the common electrodes 21 through the wiring lines 57. Specifically, a voltage applied to the n-th common electrode 21 in an odd-numbered frame (vertical scanning period) Tf is V0 in the n-th selection period (horizontal scanning period) Th in the frame; whereas the voltage is V4 in non-selection periods (that is, selection periods of the common electrodes 21 other than the n-th common electrode 21). In contrast, the polarity of the applied voltage in an even-numbered frame Tf is inverted with respect to that of the applied voltage in an odd-numbered frame, so that a voltage V5 is applied in the selection period Th and a voltage V1 is applied in the non-selection periods. The data signals supplied to the segment electrodes 31 have a voltage level of V3 or V5 in an odd-numbered frame in accordance with images to be displayed; whereas the data signals have a voltage level of V0 or V2 in an even-numbered frame.

When the voltage V0 is applied to the n-th common electrode 21 from the top in FIG. 1 (that is, the n-th common electrode 21 is selected), the voltage V4 is applied to the common electrodes 21 from the (n+1)-th common electrode 21 onward. Hence, a voltage of |V0-V4| is applied to the liquid crystals 47 at the cross sections F between the wiring line connected to the n-th common electrode 21 and the common electrodes 21 from the (n+1)-th common electrode 21 onward. As a result, lighting-up at cross sections may occur at the cross sections F where the subpixels should not normally light up.

According to this embodiment, in order to prevent lighting-up at cross sections from occurring, a duty ratio and a bias ratio are determined such that the effective value Vcross of a voltage applied to the liquid crystal 47 at the cross section F in one frame (hereinafter referred to as “cross-section-voltage effective value”) becomes smaller than the effective value Voff of a voltage applied to a subpixel for turning off the subpixel. The following is a detailed description.

When the scanning signals have the voltage waveforms shown in FIG. 5, the effective value Von of a voltage applied to the liquid crystal 47 at a subpixel for turning on the subpixel in one frame (hereinafter referred to as “on-voltage effective value”), the effective value Voff of a voltage applied to the liquid crystal 47 at a subpixel for turning off the subpixel in one frame (hereinafter referred to as “off-voltage effective value”), and the cross-section-voltage effective value Vcross described above are given by the following equations:

$$\begin{matrix}Formula 1 & \\ \begin{matrix}Von = \sqrt{\frac{1}{N} \times {Vop}^{2} + \frac{N - 1}{N} \times {( \frac{1}{a} \times Vop )}^{2}} \\ = Vop \times \sqrt{\frac{1}{N} + \frac{N - 1}{N} \times {( \frac{1}{a} )}^{2}}\end{matrix} & ( 1 ) \\ Voff = Vop \times \sqrt{\frac{1}{N} \times {( \frac{a - 2}{a} )}^{2} + \frac{N - 1}{N} \times {( \frac{1}{a} )}^{2}} & ( 2 ) \\ \begin{matrix}Vcross = \sqrt{\frac{2}{N} \times {( Vop \times \frac{a - 1}{a} )}^{2}} \\ = Vop \times \sqrt{\frac{2}{N} \times {( \frac{a - 1}{a} )}^{2}}\end{matrix} & ( 3 )\end{matrix}$$

In these equations, “N” denotes a reciprocal of a duty ratio (1/N) (that is, a duty value). The duty ratio (1/N) is normally defined as a ratio of a time length Th of the selection period for each of the common electrodes 21 to a time length Tf of one frame (Th/Tf). In contrast, “a” in equations (1) to (3) denotes a reciprocal of a bias ratio (1/a). This “a” is represented as a “bias value” in the following description. As shown in FIG. 6, the bias value a is defined as Vop/Vx, where Vop denotes the sum (liquid-crystal-display driving voltage) of the absolute value of a peak value of a scanning signal applied to the common electrodes 21 during the selection period for turning on the corresponding subpixel and the absolute value of a peak value of a data signal applied to the segment electrodes 31, and Vx denotes the absolute value of a voltage applied to the liquid crystal 47 at the corresponding subpixel during the non-selection periods.

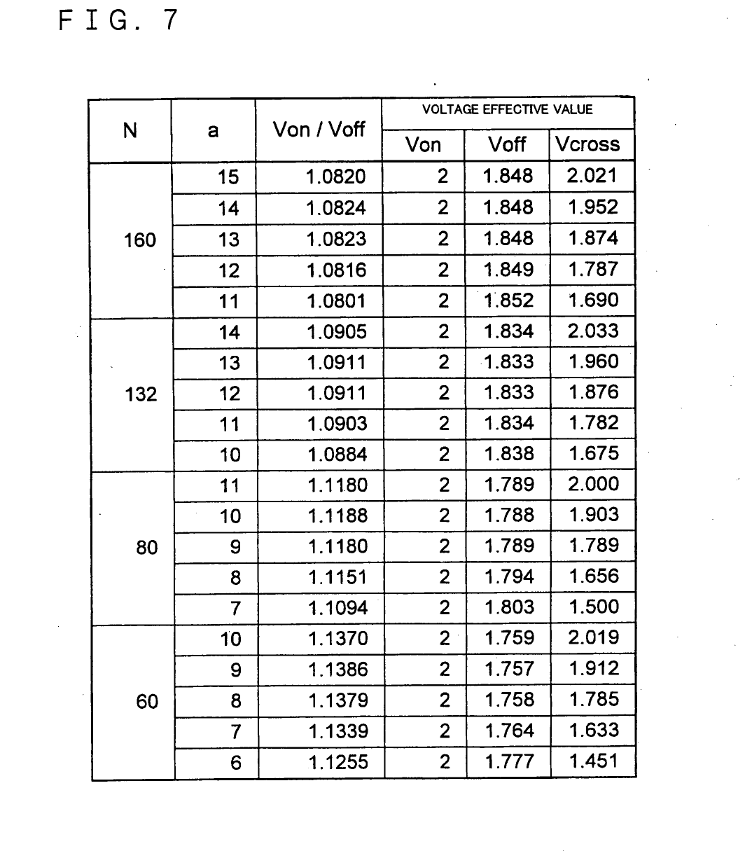

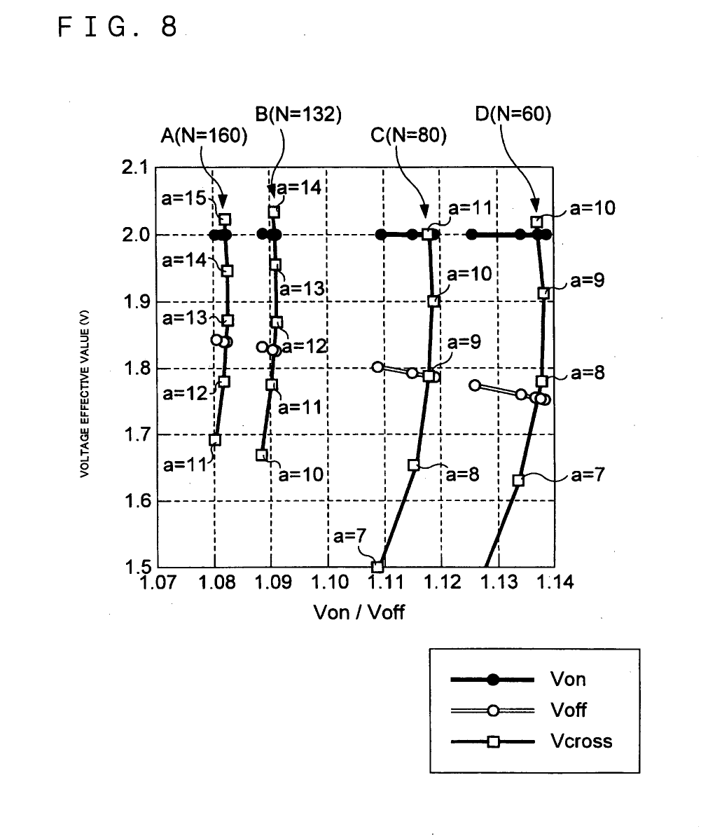

FIG. 7 is a table showing the specific values of the on-voltage effective value Von, the off-voltage effective value Voff, and the cross-section-voltage effective value Vcross, which are given by equations (1) to (3) when the duty value N and the bias value a are varied. FIG. 8 is a graph in which the on-voltage effective value Von, the off-voltage effective value Voff, and the cross-section-voltage effective value Vcross are plotted in accordance with the figures in the table in FIG. 7. Referring to FIG. 8, the horizontal axis represents the ratio of the on-voltage effective value Von to the off-voltage effective value Voff (Von/Voff) and the vertical axis represents the voltage effective value. A characteristic A represents the characteristic when the duty value N is set to “160”, a characteristic B represents the characteristic when the duty value N is set to “132”, a characteristic C represents the characteristic when the duty value N is set to “80”, and a characteristic D represents the characteristic when the duty value N is set to “60”.

The table in FIG. 7, the graph in FIG. 8, and equation (3) show that the cross-section-voltage effective value Vcross is decreased as the bias value a decreases when the duty ratio (1/N) is set to a certain value and that the cross-section-voltage effective value Vcross is smaller than the off-voltage effective value Voff at certain bias values a (or certain bias ratios 1/a). For example, if the bias value a is set to “12” when the duty value N is “160”, as shown by the characteristic A in FIG. 8, the cross-section-voltage effective value Vcross is smaller than the off-voltage effective value Voff. Similarly, if the bias value a is set to “11” when the duty value N is “132”, the bias value a is set to “8” when the duty value N is “80”, and the bias value a is set to “7” when the duty value N is “60”, the cross-section-voltage effective values Vcross are smaller than the off-voltage effective values Voff.

In the liquid crystal device 10 according to this embodiment, in view of the above description, the duty ratio (or the duty value) and the bias ratio (or the bias value) are set such that the cross-section-voltage effective value Vcross becomes smaller than the off-voltage effective value Voff. In such a driving method, the orientation of the liquid crystal 47 at the cross section F hardly varies, as in a case where the subpixels are turned off. Accordingly, the lighting-up at cross sections can be avoided, in this embodiment, even in the structure in which the common electrodes 21 intersect with the wiring lines 57.

Only from the point of keeping the contrast of displayed images to a higher level, the ratio of the on-voltage effective value Von to the off-voltage effective value Voff (Von/Voff) is desirably set to a maximum value. A bias value a0 for making the effective value ratio (Von/Voff) a maximum value, which is known as an optimum bias value, is given by the following equation (4):

Formula 2

a0=\sqrt{N}+1 (4)

According to equation (4), the bias values a0 for making the effective value ratio (Von/Voff) a maximum value by using the duty values N shown in FIGS. 7 and 8 are as follows: the optimum bias value a0 is “13.649” when the duty value N is “160”, the optimum bias value a0 is “12.489” when the duty value N is “132”, the optimum bias value a0 is “9.944” when the duty value N is “80”, and the optimum bias value a0 is “8.746” when the duty value N is “60”. However, as seen from FIGS. 7 and 8, since the cross-section-voltage effective value Vcross is larger than the off-voltage effective value Voff when the bias value a is set to the optimum bias value a0, it is impossible to perfectly avoid the lighting-up at cross sections. According to this embodiment, intentionally setting the bias value a to a value smaller than the optimum bias value a0 causes the cross-section-voltage effective value Vcross to be smaller than the off-voltage effective value Voff.

However, making the bias value a too small, compared with the optimum bias value a0 described above, causes the decrease in contrast of displayed images to be too large to be ignored. From these points of view, it is desirable that the bias value a in this embodiment be selected from among values within a range between the bias value a when the cross-section-voltage effective value Vcross is smaller than the off-voltage effective value Voff and the bias value a when the contrast of displayed images is larger than a certain level (that is, when the effective value ratio (Von/Voff) is larger than a certain value). In other words, the bias ration (1/a) is desirably selected such that the bias value a is a value within this range.

B: Other Driving Methods

Although the scanning signals shown in FIG. 5 are supplied to the common electrodes 21 in the above embodiment (this driving method is hereinafter referred to as a “first driving method”), appropriately selecting the duty ratio (1/N) or the bias ratio (1/a) to cause the cross-section-voltage effective value Vcross to be smaller than the off-voltage effective value Voff allows the lighting-up at cross sections to be avoided in the subsequent driving methods in which scanning signals having other signal waveforms are supplied to the common electrodes 21. The structures in which the lighting-up at cross sections is avoided by using second and third driving methods that differ from the first driving method will now be described. The structures of the liquid crystal device 10 in the second and third driving methods described below are the same as one shown in FIG. 1.

B-1: Second Driving Method

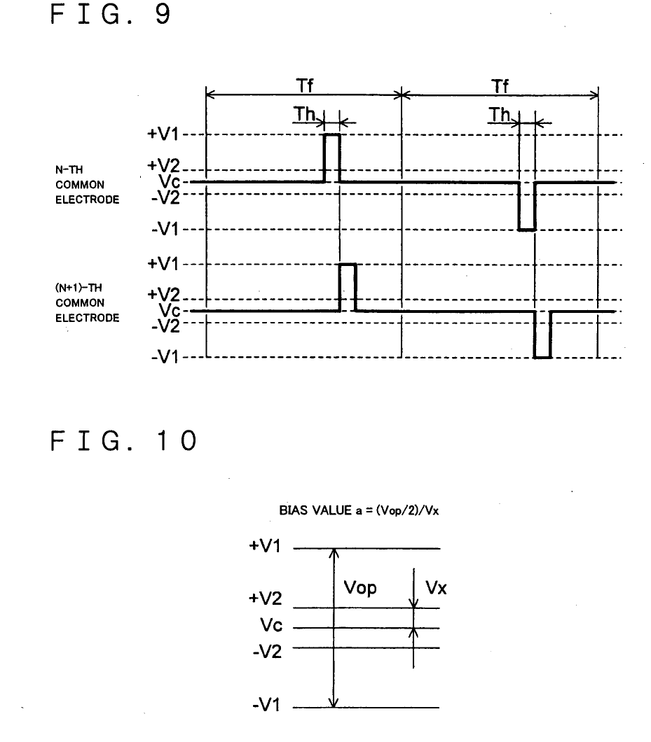

FIG. 9 is a timing chart showing the signal waveforms of scanning signals supplied to the n-th and (n+1)-th common electrodes 21 when the liquid crystal device 10 is driven by the second driving method. As shown in FIG. 9, in the second driving method, a voltage +V1 or −V1 is applied to each of the common electrodes 21 during the selection period of the corresponding common electrode 21, while a voltage Vc is applied during other periods (that is, during periods in which other common electrodes 21 are selected). A voltage +V2 or −V2 is applied to the segment electrodes 31. The midpoint potential between the voltage +V1 and the voltage −V1 coincides with the midpoint potential Vc between the voltage +V2 and the voltage −V2.

The on-voltage effective value Von, the off-voltage effective value Voff, and the cross-section-voltage effective value Vcross are given by the following equations in the second driving method:

$$\begin{matrix}Formula 3 & \\ \begin{matrix}Von = \sqrt{\frac{1}{N} \times {( \frac{Vop}{2} + \frac{Vop}{2 \times a} )}^{2} + \frac{N - 1}{N} \times {( \frac{Vop}{2 \times a} )}^{2}} \\ = \frac{Vop}{2} \times \sqrt{\frac{1}{{a}^{2}} + \frac{1 + \frac{2}{a}}{N}}\end{matrix} & ( 5 ) \\ Voff = \frac{Vop}{2} \times \sqrt{\frac{1}{{a}^{2}} + \frac{1 - \frac{2}{a}}{N}} & ( 6 ) \\ \begin{matrix}Vcross = \sqrt{\frac{2}{N} \times {( \frac{Vop}{2} )}^{2}} \\ = Vop \times \sqrt{\frac{1}{2 \times N}}\end{matrix} & ( 7 )\end{matrix}$$

Referring to FIG. 10, the voltage Vop in equations (5) to (7) corresponds to an amplitude value of scanning signals and the voltage Vx corresponds to a peak value of data signals. A bias value a in the second driving method is defined as a=(Vop/2)/Vx. In other words, the bias value a is given by dividing the absolute value of a peak value of scanning signals (Vop/2) by a peak value of data signals (Vx). Since the bias ratio (1/a) is a reciprocal of the bias value a, as described above, it is understood that the bias ratio (1/a) in the second driving method is given by Vx/(Vop/2).

In this structure, as in the description with reference to FIGS. 7 and 8, the cross-section-voltage effective value Vcross is decreased as the bias value a decreases. Hence, appropriately selecting the duty value N (or duty ratio) and the bias value a (or bias ratio) causes the cross-section-voltage effective value Vcross to be smaller than the off-voltage effective value Voff in the second driving method. With the structure in which the subpixels are turned on or off by using the duty value N and the bias value a that are selected so as to meet the condition (Vcross<Voff), the lighting-up at cross sections can be avoided at the cross sections F between the common electrodes 21 and the wiring lines 57.

B-2: Third Driving Method

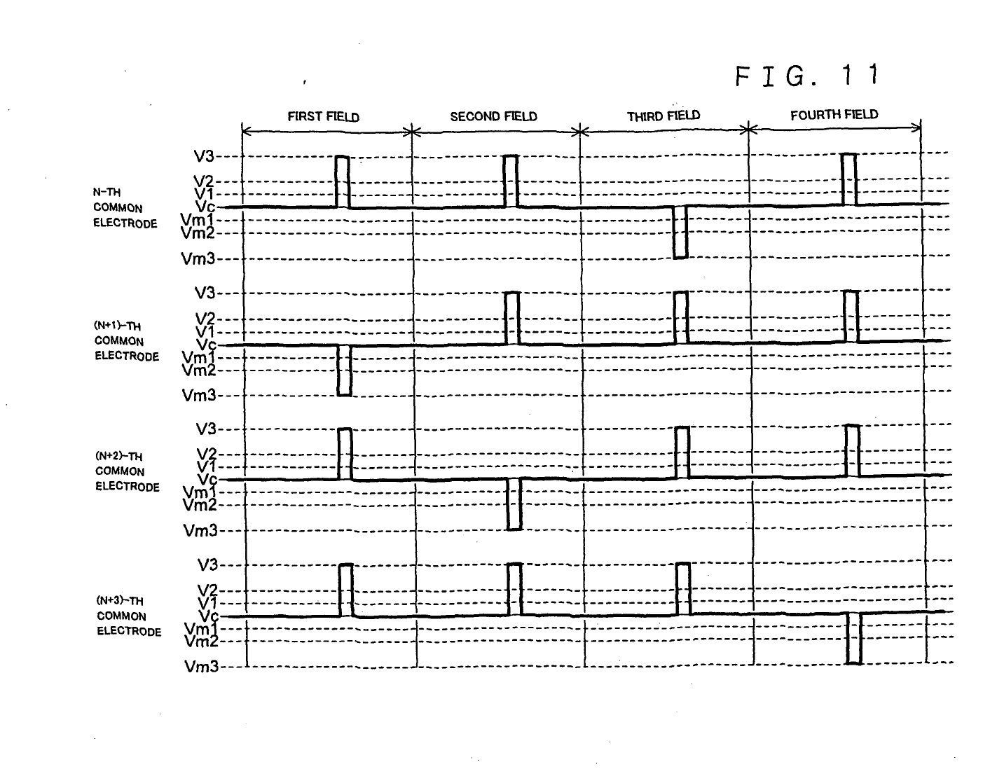

A third driving method is a multi-line selection (MLS) method in which a plurality of common electrodes 21 are simultaneously selected. Scanning signals supplied to the common electrodes 21 in the third driving method have signal waveforms, for example, shown in FIG. 11. Referring to FIG. 11, it is assumed that four common electrodes 21 are simultaneously selected in each field that is a quarter period of one frame. The voltage level of data signals is a voltage V1, V2, Vc, Vm1, or Vm2 in accordance with images to be displayed. The voltage V2 is twice the voltage V1 and the voltage Vm2 is twice the voltage Vm1. The voltages Vm1 and Vm2 have inverted polarities with respect to the voltages V1 and V2, respectively, on the basis of the voltage Vc.

The on-voltage effective value Von, the off-voltage effective value Voff, and the cross-section-voltage effective value Vcross are given by the following equations in the third driving method:

$$\begin{matrix}Formula 4 & \\ \begin{matrix}Von = \sqrt{\frac{3 \times {( \frac{Vop}{2} + \frac{Vop}{a} )}^{2} + {( \frac{Vop}{2} - \frac{Vop}{a} )}^{2} + ( N - 4 ) \times {( \frac{Vop}{a} )}^{2}}{N}} \\ = Vop \times \sqrt{\frac{1 + \frac{2}{a} + N \times \frac{2}{{a}^{2}}}{N}} \\ = Vop \times \sqrt{\frac{1}{{a}^{2}} + \frac{1 + \frac{2}{a}}{N}}\end{matrix} & ( 8 ) \\ Voff = Vop \times \sqrt{\frac{1}{{a}^{2}} + \frac{1 - \frac{2}{a}}{N}} & ( 9 ) \\ Vcross = Vop \times \sqrt{\frac{2}{N}} & ( 10 )\end{matrix}$$

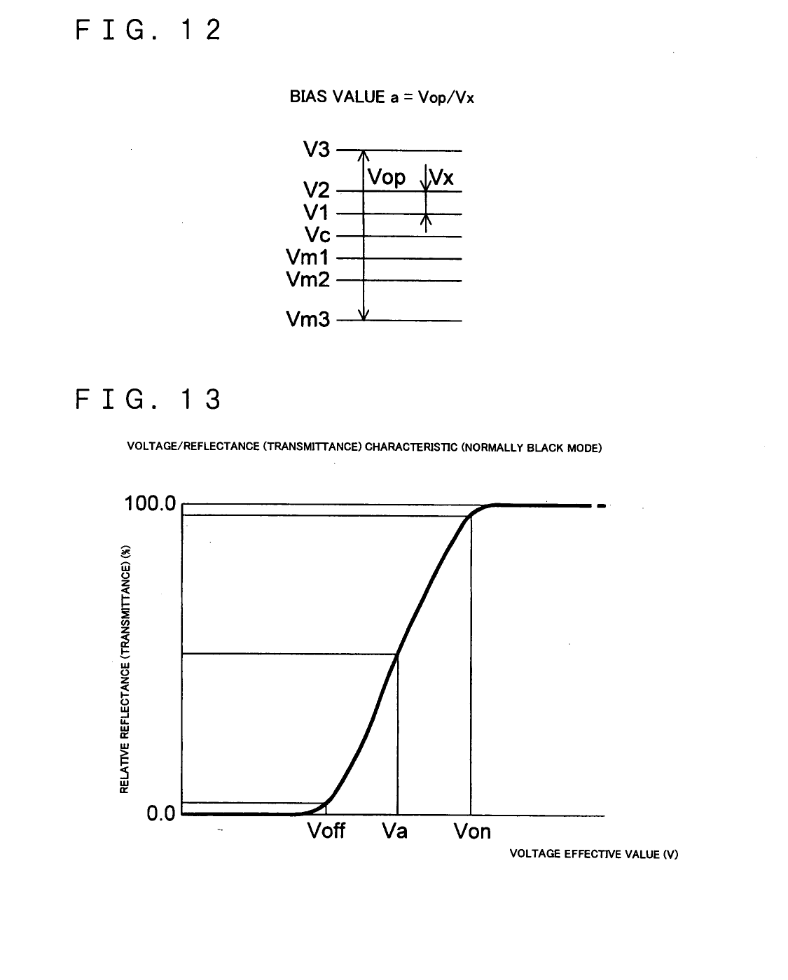

Referring to FIG. 12, the voltage Vop in equations (8) to (10) corresponds to an amplitude value of scanning signals and the voltage Vx corresponds to the absolute value of the difference between the voltage V1 and the voltage V2 (or the difference between the voltage Vm1 and the voltage Vm2). A bias value a in the third driving method is defined as a=Vop/Vx. Accordingly, the bias ratio (1/a) is given by Vx/Vop. The duty value N is defined as a ratio of a time length of the period during which four common electrodes 21 are simultaneously selected to a time length of one field (a ratio of the sum of time lengths of the periods during which four common electrodes 21 are simultaneously selected in one frame to a time length of one frame).

In this structure, as in the description with reference to FIGS. 7 and 8, the cross-section-voltage effective value Vcross is decreased as the bias value a decreases. Hence, appropriately selecting the duty value N (or duty ratio) and the bias value a (or bias ratio) causes the cross-section-voltage effective value Vcross to be smaller than the off-voltage effective value Voff in the third driving method. With the structure in which the subpixels are turned on or off by using the duty value N and the bias value a that are selected so as to meet this condition, the lighting-up at cross sections can be avoided at the cross sections F between the common electrodes 21 and the wiring lines 57.

C: Modifications

While the embodiments of the present invention have been exemplified, it is to be understood that modifications will be apparent to those skilled in the art without departing from the spirit of the invention. The following modifications can be embodied.

C-1: First Modification

It is assumed, in the embodiments described above, that the cross-section-voltage effective value Vcross that is applied to the liquid crystals 47 at the cross sections F between the common electrodes 21 and the wiring lines 57 is made smaller than the off-voltage effective value Voff that is applied to the corresponding subpixel for turning off the subpixel. However, even when the cross-section-voltage effective value Vcross is larger than the off-voltage effective value Voff, the lighting-up at cross sections can be effectively suppressed if the cross-section-voltage effective value Vcross is smaller than the on-voltage effective value Von.

It is assumed here that a normally black mode is adopted in the liquid crystal device 10. In the normally black mode, dark display is employed in states where no voltage is applied to the liquid crystals 47 and the subpixels are turned off; whereas bright display is employed in a state where the subpixels are turned on. The relationship between the effective value of a voltage applied to the liquid crystals 47 and a relative reflectance (or relative transmittance) is as shown in FIG. 13. The relative reflectance here is given by normalization of the light intensity that is reflected from the surface of the reflective conductive layer 311 and emitted from the observation side when light is incident on the observation side of the liquid crystal device 10. A minimum value is defined as 0% and a maximum value is defined as 100% in the normalization. As shown in FIG. 13, the relative reflectance of the liquid crystals 47 nonlinearly increases in accordance with the effective value of an applied voltage. Namely, the relative reflectance is close to 0% when the off-voltage effective value Voff is applied and the relative reflectance is close to 100% when the on-voltage effective value Von is applied.

As seen from FIG. 13, even when the effective value of a voltage applied to the liquid crystals 47 is larger than the off-voltage effective value Voff, the relative reflectance of the liquid crystals 47 at this time becomes smaller than the relative reflectance when the on-voltage effective value Von is applied to the liquid crystals 47 if the effective value of the voltage applied to the liquid crystals 47 is smaller than the on-voltage effective value Von. Hence, if the cross-section-voltage effective value Vcross is smaller than the on-voltage effective value Von, the lighting-up at cross sections can be effectively suppressed, compared with a case in which a voltage effective value that is larger than the on-voltage effective value Von is applied to the liquid crystals 47 at the cross sections F.

According to the present invention, it is sufficient for the cross-section-voltage effective value Vcross to be smaller than the on-voltage effective value Von and the cross-section-voltage effective value Vcross is not necessarily smaller than the off-voltage effective value Voff. In other words, it is sufficient for the cross-section-voltage effective value Vcross to be selected such that the relative reflectance (relative transmittance) of the liquid crystals 47 at the cross sections F becomes lower than the relative reflectance (relative transmittance) of a subpixel that is turned on. However, in order to properly suppress the lighting-up at cross sections, it is desirable that the duty ratio (1/N) and the bias ratio (1/a) be selected such that the cross-section-voltage effective value Vcross becomes smaller than a voltage effective value Va (refer to FIG. 13) that is the intermediate value between the on-voltage effective value Von and the off-voltage effective value Voff.

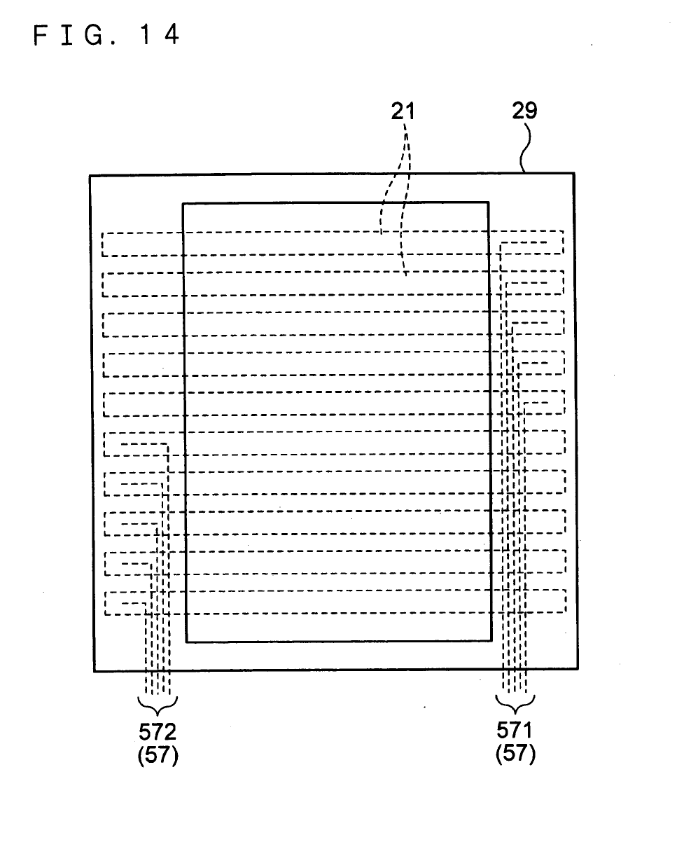

In the structure in which the cross-section-voltage effective value Vcross is made larger than the off-voltage effective value Voff, a light-shielding layer 29 that overlays the cross sections F may be provided on the observed substrate 20 for fully eliminating the visibility of the lighting-up at cross sections. FIG. 14 is a plan view specifically showing the structure of the light-shielding layer 29. The light-shielding layer 29 in FIG. 14 is a layer member for absorbing at least part of radiated light and is formed so as to overlay the cross sections F between the common electrodes 21 and the wiring lines 57, viewed from the direction perpendicular to the substrates. The light-shielding layer 29 may be made of a resin material containing black colorant such as carbon black or pigment, as well as metal such as chromium (Cr). The shape of the light-shielding layer 29 is not limited to the substantially rectangular frame shown in FIG. 14. Namely, it is sufficient for the light-shielding layer 29 to overlay the cross sections F between the wiring lines 57 and the common electrodes 21. Although the light-shielding layer 29 is provided in the driving method in which the cross-section-voltage effective value Vcross is made larger than the off-voltage effective value Voff, the light-shielding layer 29 may be provided even in a driving method in which the cross-section-voltage effective value Vcross is made smaller than the off-voltage effective value Voff for surely avoiding the lighting-up at cross sections.

C-2: Second Modification

Although the liquid crystal device 10, having the color filters 25, which is capable of color display is exemplified in the embodiments and the first modification described above, the present invention can be embodied by a monochrome-display liquid crystal device without a color filter. The on-voltage effective value Von is defined as the effective value of a voltage applied to a subpixel for turning on the subpixel and the off-voltage effective value Voff is defined as the effective value of a voltage applied to a subpixel for turning off the subpixel in the embodiments described above. In contrast, in the monochrome-display liquid crystal device, the effective value of a voltage applied to a “pixel (dot)” corresponding to the intersection of a common electrode and a segment electrode for turning on the pixel is defined as the on-voltage effective value Von and the effective value of a voltage applied to a “pixel (dot)” corresponding to the intersection of a common electrode and a segment electrode for turning off the pixel is defined as the off-voltage effective value Voff. In other words, the “pixel” in the present invention means a minimum unit in which the orientation of liquid crystals can be independently varied. Hence, a “subpixel” corresponding to one color corresponds to a “pixel” in the present invention in the color-display liquid crystal device in the embodiments described above; whereas a “pixel (dot)” at an intersection of electrodes corresponds to a “pixel” in the present invention in the monochrome-display liquid crystal device.

C-3: Third Modification

Although the common electrodes 21 provided on the observed substrate 20 are electrically connected through the conductive particles in the above embodiments, the segment electrodes 31 provided on the rear substrate 30 may be electrically connected through the conductive particles. Although the common electrodes 21 are provided on the observed substrate 20 and the segment electrodes 31 are provided on the rear substrate 30 in the above embodiments, the segment electrodes 31 may be provided on the observed substrate 20 and the common electrodes 21 may be provided on the rear substrate 30. In other words, a “first electrode” and a “second electrode” of the present invention may correspond to either the common electrodes 21 or the segment electrodes 31 of the above embodiments. Either a “first substrate” or a “second substrate” of the present invention may be provided on the observation side (or the rear side).

D: Electronic Equipment

Electronic equipment employing the liquid crystal device according to the present invention as a display device will now be described.

D-1: Mobile Computer

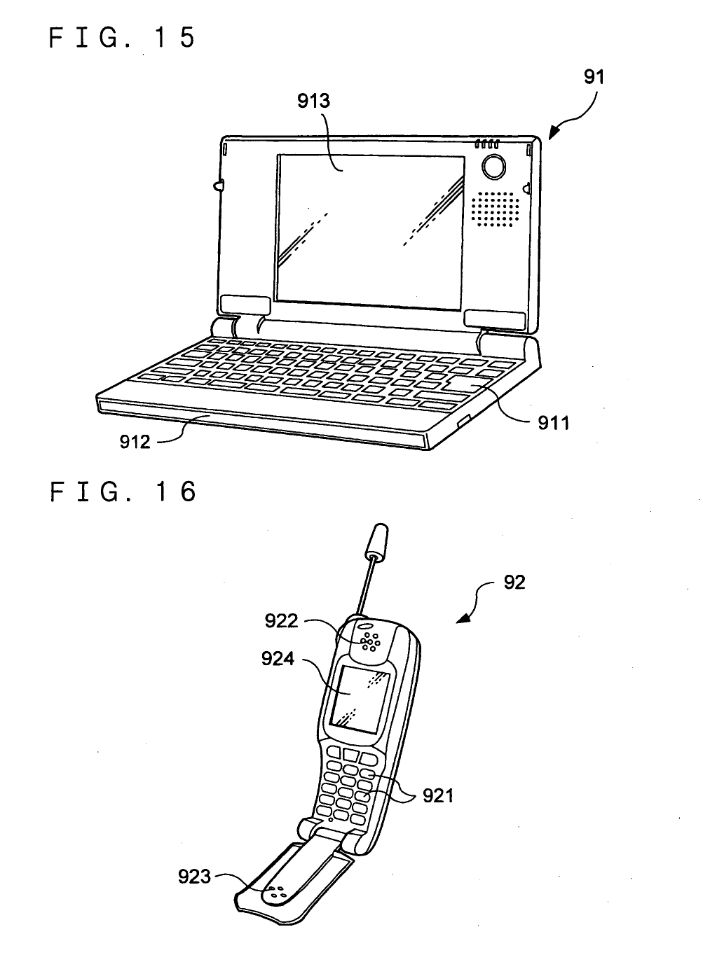

A portable personal computer 91 (so-called a laptop personal computer) having the liquid crystal device according to the present invention in its display unit will now be described. FIG. 15 is a perspective view showing the structure of the personal computer 91. Referring to FIG. 15, the personal computer 91 has a main unit 912 provided with a keyboard 911 and a display unit 913 to which the liquid crystal device according to the present invention is applied.

D-2: Mobile Phone

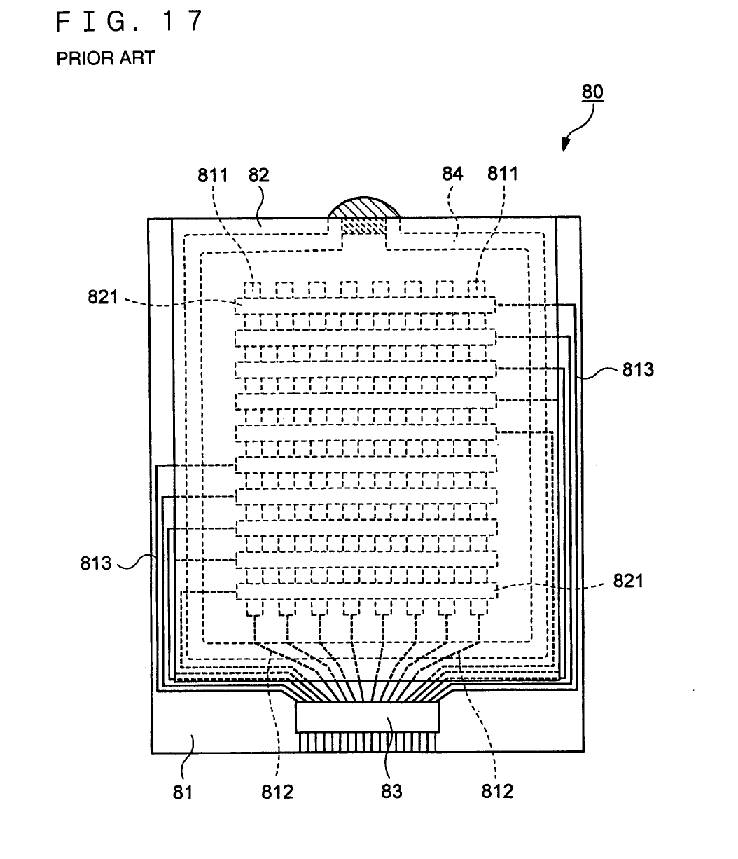

A mobile phone 92 having the liquid crystal device according to the present invention in its display unit will now be described. FIG. 16 is a perspective view showing the structure of the mobile phone 92. Referring to FIG. 16, the mobile phone 92 has a plurality of operation buttons 921, an earpiece 922, a mouthpiece 923, and a display unit 924 to which the liquid crystal device according to the present invention is applied.

Electronic equipment to which the liquid crystal device according to the present invention can be applied includes a liquid crystal television, a video cassette recorder having a viewfinder and a direct-viewing monitor, a car navigation system, a pager, an electronic notebook, a calculator, a word processor, a workstation, a video phone, a point-of-sale (POS) terminal, a digital still camera, and a projector using the liquid crystal device according to the present invention as a light bulb, in addition to the personal computer 91 in FIG. 15 and the mobile phone 92 in FIG. 16.

As described above, according to the present invention, the frame area can be reduced in size without defects, such as reduction in reliability of wiring lines or short-circuited wiring.

The entire disclosure of Japanese Patent Application Nos. 2002-275760 filed Sep. 20, 2002 and 2003-321981 filed Sep. 12, 2003 are incorporated by reference.

1. A liquid crystal device having liquid crystals between a first substrate and a second substrate that faces the first substrate through a sealing material, in which pixels corresponding to intersections of a plurality of first electrodes on the first substrate and a plurality of second electrodes on the second substrate are turned on or off in accordance with voltages applied to the first electrodes and the second electrodes, the liquid crystal device comprising:
wiring lines, provided on the second substrate, each wiring line corresponding to one of the first electrodes on the first substrate, the wiring lines being connected to the corresponding first electrodes and each having a part extending in a display area surrounded by a frame area which does not contribute to display, the frame area being arranged outside the sealing material, each wiring line intersecting at least one first electrode other than the corresponding first electrode at intersecting sections in the display area; and
a drive circuit applying a voltage to the first electrodes through the wiring lines, each of the first electrodes being supplied with a first voltage through the corresponding wiring line when selected, each the first electrodes being supplied with a second voltage through the corresponding wiring line when not selected, a first effective value of a voltage applied to the liquid crystals at the intersecting sections being smaller than a second effective value of a voltage applied to a pixel for turning on the pixel, the first effective value being based on a difference between the first voltage and the second voltage, the second effective value being based on a difference between the first voltage and a voltage supplied to one of the second electrodes for turning on a pixel.

2. A liquid crystal device according to claim 1, wherein at least one of a duty ratio and a bias ratio is determined such that the first effective value of the voltage applied to the liquid crystals at the cross sections becomes smaller than the second effective value of the voltage applied to the corresponding pixel for turning on the pixel.

3. A liquid crystal device according to claim 1, wherein the first effective value of the voltage applied to the liquid crystals at the cross sections is smaller than a third effective value of a voltage applied to a pixel for turning off the pixel.

4. A liquid crystal device according to claim 1, wherein the first effective value of the voltage applied to the liquid crystals at the cross sections is smaller than an intermediate value between the second effective value of the voltage applied to a pixel for turning on the pixel and a third effective value of a voltage applied to a pixel for turning off the pixel.

5. A liquid crystal device according to claim 1, the liquid crystal device comprising:
a light-shielding layer provided on one of the first substrate and the second substrate so as to overlay the cross sections.

6. Electronic equipment provided with the liquid crystal device according to claim 1.

7. A method for driving a liquid crystal device including a first substrate and a second substrate that are opposed to each other through a sealing material, liquid crystals being sandwiched between the first substrate and the second substrate; a plurality of first electrodes provided on the first substrate; a plurality of second electrodes provided on the second substrate; and wiring lines, provided on the second substrate, each wiring line corresponding to one of the first electrodes on the first substrate, the wiring lines being connected to the corresponding first electrodes and each having a part extending in a display area surrounded by a frame area which does not contribute to display, the frame area being arranged outside the sealing material, in which pixels corresponding to intersections of the first electrodes and the second electrodes are turned on or off in accordance with voltages applied to the first electrodes and the second electrodes, each wiring line intersecting at least one first electrode other than the corresponding first electrode at intersecting sections in the display area, the method comprising:
applying a voltage to the first electrodes through the wiring lines, each of the first electrodes being supplied with a first voltage through the corresponding wiring line when selected, each of the first electrodes being supplied with a second voltage through the corresponding wiring line when not selected, a first effective value of a voltage applied to the liquid crystals at the cross sections being smaller than a second effective value of a voltage applied to a pixel for turning on the pixel, the first effective value being based on a difference between the first voltage and the second voltage, the second effective value being based on a difference between the first voltage and a voltage supplied to one of the second electrodes for turning on a pixel.

8. A method for driving a liquid crystal device, according to claim 7, wherein a voltage is applied to the plurality of first electrodes and the plurality of second electrodes by using at least one of a duty ratio and a bias ratio that are determined such that the first effective value of the voltage applied to the liquid crystals at the cross sections becomes smaller than a third effective value of a voltage applied to a pixel for turning off the pixel.

9. A method for driving a liquid crystal device, according to claim 7, wherein the first effective value of the voltage applied to the liquid crystals at the cross sections is smaller than a third effective value of a voltage applied to a pixel for turning off the pixel.

10. A method for driving a liquid crystal device, according to claim 7, wherein the first effective value of the voltage applied to the liquid crystals at the cross sections is smaller than an intermediate value between the second effective value of the voltage applied to a pixel for turning on the pixel and a third effective value of a voltage applied to a pixel for turning off the pixel.

11. A liquid crystal device comprising:
a first substrate;
a second substrate facing the first substrate with liquid crystals therebetween;
a sealing material between the first and second substrates;
a plurality of first electrodes on the first substrate;
a plurality of second electrodes on the second substrate intersecting with the plurality of first electrodes at intersections forming pixels, the pixels being turned on or off in accordance with voltages applied to the first electrodes and the second electrodes;
wiring lines on the second substrate, each wiring line corresponding to one of the first electrodes on the first substrate, the wiring lines being connected to the corresponding first electrodes, each wiring line having a part extending in a display area surrounded by a frame area which does not contribute to display, the frame area being arranged outside the sealing material, each wiring line intersecting at least one first electrode other than the corresponding first electrode at intersecting sections in the display area; and
a drive circuit applying a voltage to the first electrodes through the wiring lines, each of the first electrodes being supplied with a first voltage through the corresponding wiring line when selected, each of the first electrodes being supplied with a second voltage through the corresponding wiring line when not selected;
wherein a first effective value of a voltage applied to the liquid crystals at the cross sections is smaller than a second effective value of a voltage applied to a pixel for turning on the pixel, the first effective value being based on a difference between the first voltage and the second voltage, the second effective value being based on a difference between the first voltage and a voltage supplied to one of the second electrodes for turning on a pixel.

12. A liquid crystal device according to claim 1, wherein at least one of a duty ratio and a bias ratio is determined such that the first effective value of the voltage applied to the liquid crystals at the cross sections becomes smaller than a third effective value of a voltage applied to the corresponding pixel for turning off the pixel.
